(19) United States
(12) Patent Application Publication
(10) Pub. No.: US 2010/0195748 A1
(43) Pub. Date: Aug. 5, 2010

(54) METHOD AND SYSTEM FOR REFERENCE SIGNAL PATTERN DESIGN IN RESOURCE BLOCKS

(75) Inventors: Young-Han Nam, Richardson, TX (US); Jianzhong Zhang, Irving, TX (US); Jin-Kyu Han, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/650,898

(22) Filed: Dec. 31, 2009

Related U.S. Application Data
(60) Provisional application No. 61/206,643, filed on Feb. 2, 2009.

(51) Int. Cl. H04K 1/10; H04B 7/00

(52) U.S. Cl. 375/260; 455/509

(57) ABSTRACT

A base station is provided. The base station comprises a downlink transmit path comprising circuitry configured to transmit a plurality of reference signals in two or more resource blocks. Each resource block comprises S OFDM symbols. Each of the S OFDM symbols comprises N subcarriers, and each subcarrier of each OFDM symbol comprises a resource element. The base station further comprises a reference signal allocator configured to allocate the plurality of reference signals to selected resource elements of the two or more resource blocks according to a reference signal pattern. A same pre-coding matrix is applied across the two or more resource blocks.

### CROSS-REFERENCE TO RELATED APPLICATION(S) AND CLAIM OF PRIORITY

The present application is related to U.S. Provisional Patent No. 61/206,643, filed Feb. 2, 2009, entitled “8-TRANSMIT ANTENNA PILOT DESIGN FOR DOWNLINK COMMUNICATIONS IN A WIRELESS COMMUNICATION SYSTEM”. Provisional Patent No. 61/206,643 is assigned to the assignee of the present application and is hereby incorporated by reference into the present application as if fully set forth herein. The present application hereby claims priority under 35 U.S.C. §119(e) to U.S. Provisional Patent No. 61/206,643.

### TECHNICAL FIELD OF THE INVENTION

The present application relates generally to wireless communications and, more specifically, to a method and system for reference signal (RS) pattern design in resource blocks.

### BACKGROUND OF THE INVENTION

In 3^{rd} Generation Partnership Project Long Term Evolution (3GPP LTE), Orthogonal Frequency Division Multiplexing (OFDM) is adopted as a downlink (DL) transmission scheme.

### SUMMARY OF THE INVENTION

A base station is provided. The base station comprises a downlink transmit path comprising circuitry configured to transmit a plurality of reference signals in two or more resource blocks. Each resource block comprises S OFDM symbols. Each of the S OFDM symbols comprises N subcarriers, and each subcarrier of each OFDM symbol comprises a resource element. The base station further comprises a reference signal allocator configured to allocate the plurality of reference signals to selected resource elements of the two or more resource blocks according to a reference signal pattern. A same pre-coding matrix is applied across the two or more resource blocks.

A subscriber station is provided. The subscriber station comprising a downlink receive path comprising circuitry configured to receive a plurality of reference signals in two or more resource blocks. Each resource block comprises S OFDM symbols. Each of the S OFDM symbols comprises N subcarriers, and each subcarrier of each OFDM symbol comprises a resource element. The subscriber station further comprises a reference signal receiver configured to receive the plurality of reference signals from selected resource elements of the two or more resource blocks according to a reference signal pattern. A same pre-coding matrix is applied across the two or more resource blocks.

A method of operating a subscriber station is provided. The method comprising receiving, by way of a downlink receive path, a plurality of reference signals in two or more resource blocks. Each resource block comprises S OFDM symbols. Each of the S OFDM symbols comprises N subcarriers, and each subcarrier of each OFDM symbol comprises a resource element. The method further comprises receiving, by way of a reference signal receiver, the plurality of reference signals from selected resource elements of the two or more resource blocks according to a reference signal pattern. A same pre-coding matrix is applied across the two or more resource blocks.

A base station is provided. The base station comprises a downlink transmit path comprising circuitry configured to transmit a plurality of cell-specific reference signals across a plurality of resource blocks. The base station also comprises a reference signal allocator configured to allocate the plurality of cell-specific reference signals in an fth resource block and in every ith resource block starting from the fth resource block in the plurality of resource blocks, wherein i and f are integers, and f is a resource block offset based at least partly upon a Cell_ID of the base station.

A subscriber station is provided. The subscriber station comprises a downlink receive path comprising circuitry configured to receive a plurality of cell-specific reference signals across a plurality of resource blocks. The subscriber station also comprises a reference signal receiver configured to receive the plurality of cell-specific reference signals in an fth resource block and in every ith resource block starting from the fth resource block in the plurality of resource blocks, wherein i and f are integers, and f is a resource block offset based at least partly upon a Cell_ID of the base station.

A method of operating a subscriber station. The method comprises receiving, by way of a downlink receive path, a plurality of cell-specific reference signals across a plurality of resource blocks. The method also comprises receiving, by way of a reference signal receiver, the plurality of cell-specific reference signals in an fth resource block and in every ith resource block starting from the fth resource block in the plurality of resource blocks, wherein i and f are integers, and f is a resource block offset based at least partly upon a Cell_ID of the base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the uplink according to the principles of the present disclosure;

FIG. 2 is a high-level diagram of an OFDMA transmitter according to one embodiment of the disclosure;

FIG. 3 is a high-level diagram of an OFDMA receiver according to one embodiment of the disclosure;

FIG. 4 illustrates reference element patterns for the new reference signals according to embodiments of the disclosure;

FIG. 5 illustrates reference element patterns for different numbers of new antenna ports according to embodiments of the disclosure;

FIG. 6 illustrates reference element patterns for different numbers of new antenna ports according to embodiments of the disclosure;

FIG. 7 illustrates reference element patterns for mapping new sets of reference signals for different numbers of new antenna ports according to embodiments of the disclosure;

FIG. 8 illustrates reference element patterns for mapping new sets of reference signals for different numbers of new antenna ports according to other embodiments of the disclosure;

FIG. 9 illustrates reference element patterns for mapping new sets of reference signals for different numbers of new antenna ports according to further embodiments of the disclosure;

FIG. 10 illustrates CRS allocation according to an embodiment of the disclosure;

FIG. 11 illustrates downlink control information (DCI) formats according to an embodiment of the disclosure; and

FIG. 12 illustrates partially-precoded UE-specific reference signal ports according to an embodiment of the disclosure.

### DETAILED DESCRIPTION OF THE INVENTION

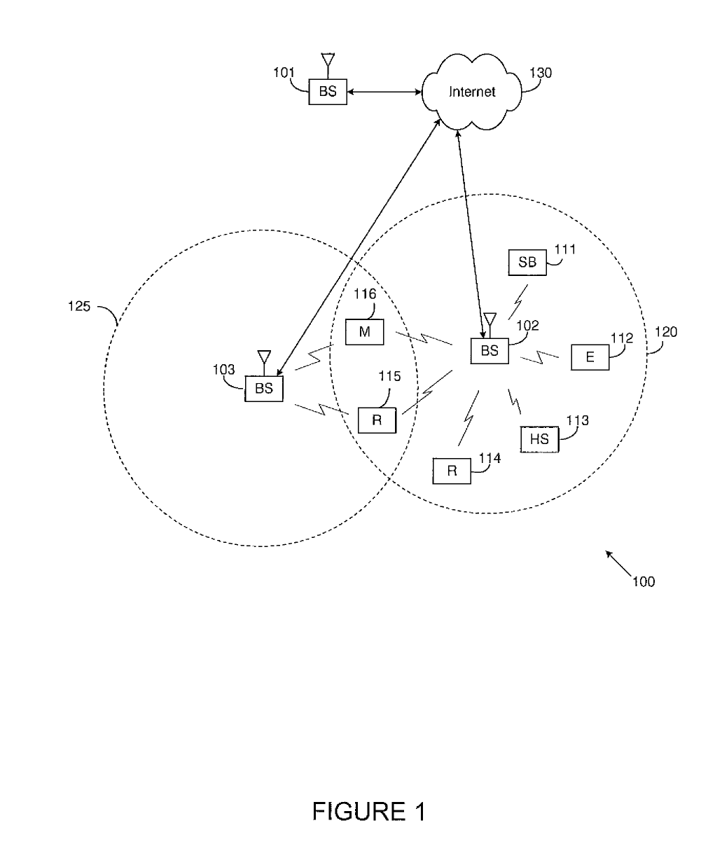

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

With regard to the following description, it is noted that the LTE term “node B” is another term for “base station” used below. Also, the LTE term “user equipment” or “UE” is another term for “subscriber station” used below.

FIG. 1 illustrates exemplary wireless network 100, which transmits messages according to the principles of the present disclosure. In the illustrated embodiment, wireless network 100 includes base station (BS) 101, base station (BS) 102, base station (BS) 103, and other similar base stations (not shown).

Base station 101 is in communication with Internet 130 or a similar IP-based network (not shown).

Base station 102 provides wireless broadband access to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

While only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

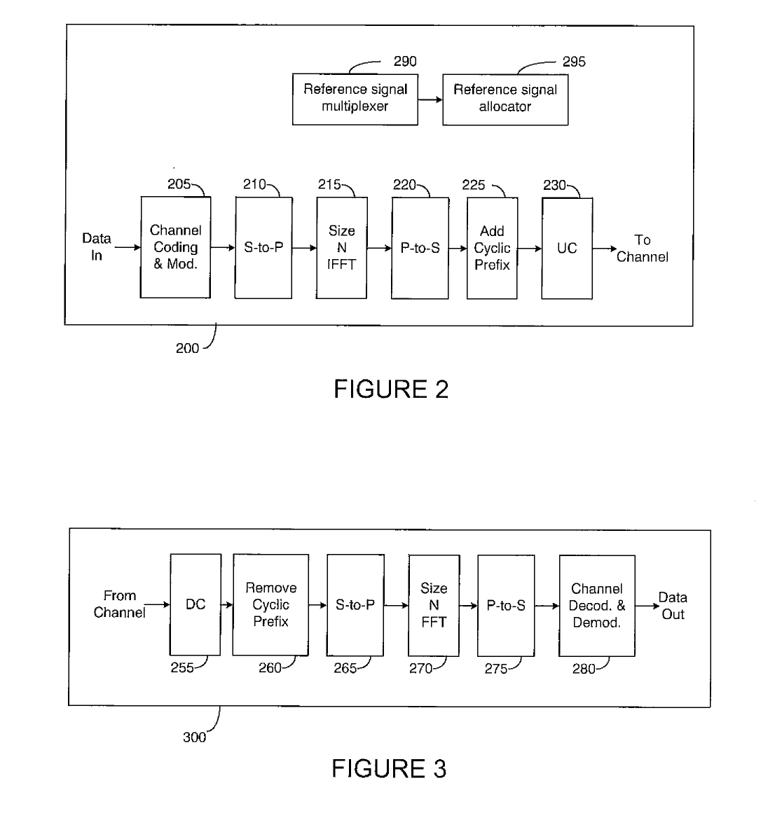

FIG. 2 is a high-level diagram of an orthogonal frequency division multiple access (OFDMA) transmit path 200. FIG. 3 is a high-level diagram of an orthogonal frequency division multiple access (OFDMA) receive path 300. In FIGS. 2 and 3, the OFDMA transmit path 200 is implemented in base station (BS) 102 and the OFDMA receive path 300 is implemented in subscriber station (SS) 116 for the purposes of illustration and explanation only. However, it will be understood by those skilled in the art that the OFDMA receive path 300 may also be implemented in BS 102 and the OFDMA transmit path 200 may be implemented in SS 116.

The transmit path 200 in BS 102 comprises a channel coding and modulation block 205, a serial-to-parallel (S-to-P) block 210, a Size N Inverse Fast Fourier Transform (IFFT) block 215, a parallel-to-serial (P-to-S) block 220, an add cyclic prefix block 225, an up-converter (UC) 230, a reference signal multiplexer 290, and a reference signal allocator 295.

The receive path 300 in SS 116 comprises a down-converter (DC) 255, a remove cyclic prefix block 260, a serial-to-parallel (S-to-P) block 265, a Size N Fast Fourier Transform (FFT) block 270, a parallel-to-serial (P-to-S) block 275, and a channel decoding and demodulation block 280.

At least some of the components in FIGS. 2 and 3 may be implemented in software while other components may be implemented by configurable hardware or a mixture of software and configurable hardware. In particular, it is noted that the FFT blocks and the IFFT blocks described in the present disclosure document may be implemented as configurable software algorithms, where the value of Size N may be modified according to the implementation.

Furthermore, although the present disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency. In some embodiments, reference signal multiplexer 290 is operable to multiplex the reference signals using code division multiplexing (CDM) or time/frequency division multiplexing (TFDM). Reference signal allocator 295 is operable to dynamically allocate reference signals in an OFDM signal in accordance with the methods and system disclosed in the present disclosure.

The transmitted RF signal arrives at SS 116 after passing through the wireless channel and reverse operations performed at BS 102. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes a method and system for reference signal (RS) pattern design in a resource block group.

The transmitted signal in each slot of a resource block is described by a resource grid of N_{RB}^{DL}N_{sc}^{RB} subcarriers and N_{symb}^{DL} OFDM symbols. The quantity N_{RB}^{DL} depends on the downlink transmission bandwidth configured in the cell and fulfills N_{RB}^{min,DL}≦N_{RB}^{DL}≦N_{RB}^{max,DL}, where N_{RB}^{min,DL} and N_{RB}^{max,DL} are the smallest and largest downlink bandwidth, respectively, supported. In some embodiments, subcarriers are considered the smallest elements that are capable of being modulated.

In case of multi-antenna transmission, there is one resource grid defined per antenna port.

Each element in the resource grid for antenna port p is called a resource element (RE) and is uniquely identified by the index pair in (k,l) in a slot where k=0, . . . , N_{RB}^{DL}N_{sc}^{RB}−1 and l=0, . . . , N_{symb}^{DL}−1 are the indices in the frequency and time domains, respectively. Resource element (k,l) on antenna port p corresponds to the complex value α_{k,l}^{(p)}. If there is no risk for confusion or no particular antenna port is specified, the index p may be dropped.

In LTE, DL reference signals (RSs) are used for two purposes. First, UEs measure channel quality information (CQI), rank information (RI) and precoder matrix information (PMI) using DL RSs. Second, each UE demodulates the DL transmission signal intended for itself using the DL RSs. In addition, DL RSs are divided into three categories: cell-specific RSs, multi-media broadcast over a single frequency network (MBSFN) RSs, and UE-specific RSs or dedicated RSs (DRSs).

Cell-specific reference signals (or common reference signals: CRSs) are transmitted in all downlink subframes in a cell supporting non-MBSFN transmission. If a subframe is used for transmission with MBSFN, only the first a few (0, 1 or 2) OFDM symbols in a subframe can be used for transmission of cell-specific reference symbols. The notation Rₚ is used to denote a resource element used for reference signal transmission on antenna port p.

An important design consideration in LTE-Advanced (LTE-A) systems is backward compatibility to allow an LTE user equipment (UE) to operate in LTE-A system while still satisfying the LTE performance target. Accordingly, the reference signals (RSs) in an LTE-A system should be designed to allow an LTE-A UE to fully exploit the new functionalities of LTE-A systems, such as relaying, coordinated multipoint transmissions and 8 transmit-antenna (8-Tx) multi-input-multi-output (MIMO) communications, while minimizing the impact on the throughput performance of LTE UEs.

The disclosure defines new sets of RSs for the 8-Tx transmissions in LTE-A. As in LTE, the new sets of RSs are classified as cell-specific RSs (or common RS, CRS) and UE-specific RSs (or dedicated RS, DRS). CRSs can be accessed by all the UEs within the cell covered by the eNodeB regardless of the specific time/frequency resource allocated to the UEs. CRSs can be used for CQI/PMI/RI measurement and/or demodulation at a UE. Conversely, DRSs are transmitted by the eNodeB only within certain resource blocks that only a subset of UEs in the cell are allocated to receive the packet. Accordingly, the packets are accessed only by the subset of UEs. In resources where a DRS pattern is defined, one pre-coding matrix is used.

In one embodiment of the disclosure, new sets of RSs (NRSs) that can be used as either CRS or DRS or both are added in a resource block (RB) where an LTE CRS is already in place. In particular embodiments, the NRS REs in an OFDM symbol are spaced apart by having a few data REs between two consecutive RS REs so that cell-specific frequency shifting can be applied for interference management. When cell-specific frequency shifting is applied, the subcarrier indices of RS REs may circularly shift by an integer number determined by the Cell_ID.

For example, three new CRSs and/or DRSs are mapped in some RBs in an LTE-A system in addition to the existing two (or four) CRSs.

In a specific embodiment, a few additional OFDM symbols in a subframe (other than the OFDM symbols where neither LTE CRS 0 and 1 (or 0, 1, 2 and 3) nor the LTE physical downlink control channel (PDCCH) is allocated) are chosen for the mapping of new RS REs. In each of these OFDM symbols, three (or four) RS REs are allocated on the 12 subcarriers in an RB in such a way that two adjacent RS REs are spaced apart by two (or three) data REs.

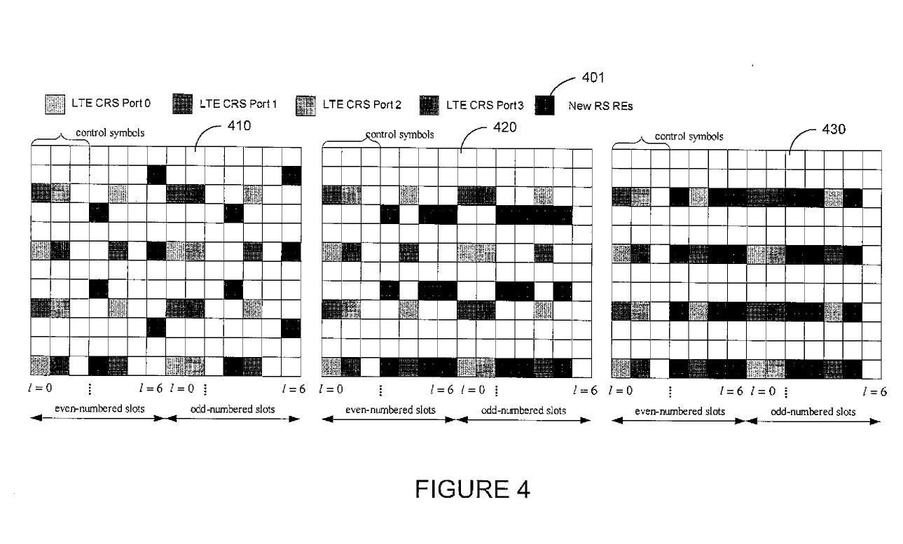

FIG. 4 illustrates reference element patterns for the new reference signals according to embodiments of the disclosure.

As shown in FIG. 4, 12 NRS REs 401 are mapped in resource block 410. 18 NRS REs 401 are mapped in resource block 420, and 24 NRS REs 401 are mapped in resource block 430. FIG. 4 illustrates three NRS RE patterns that can be used in RBs where either LTE CRS 0-1 or LTE CRS 0-3 are already in place. In resource block 410, four OFDM symbols are chosen for NRS RE mapping, OFDM symbols 3 and 6 in slot 1 and OFDM symbols 3 and 6 in slot 2. Resource blocks 420 and 430 show NRS RE mapping examples that use six OFDM symbols for NRS RE mapping.

Although FIG. 4 shows embodiments in which four and six OFDM symbols are used for NRS RE mapping, one of ordinary skill in the art would recognize that any number of OFDM symbols could be used for NRS RE mapping without departing from the scope or spirit of the disclosure.

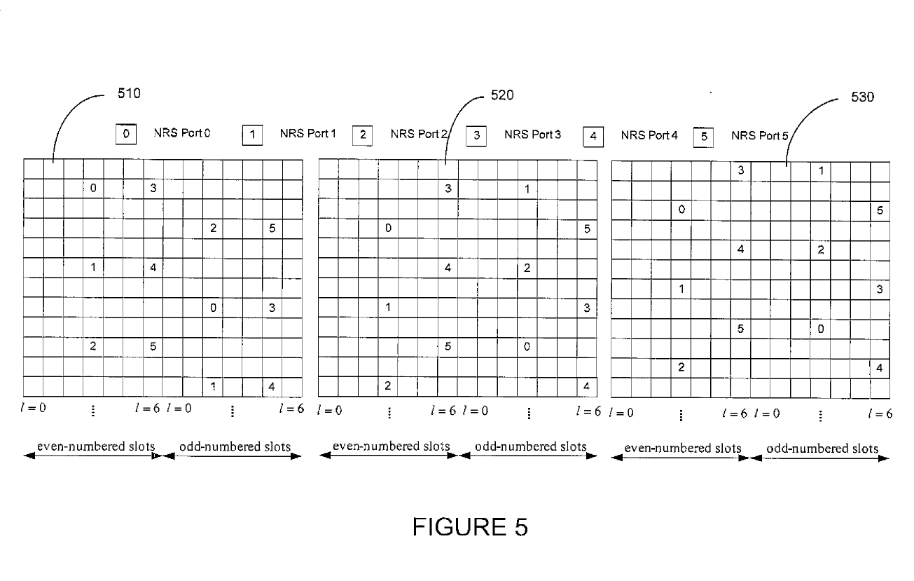

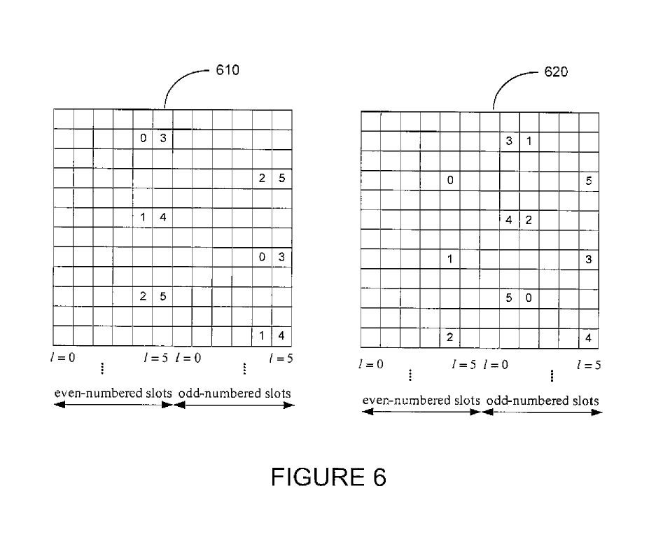

FIGS. 5 and 6 illustrate reference element patterns for different numbers of new antenna ports according to embodiments of the disclosure.

As shown in FIGS. 5 and 6, reference signals for different numbers of new antenna ports can be mapped onto the NRS patterns of the disclosure. In the NRS RE patterns shown, NRSs for 6 new antenna ports are mapped on the 12 NRS REs in an RB with two NRS REs per each new antenna port. The labels on the RS REs in FIGS. 5 and 6 represent the indices of the NRS ports mapped onto the RS REs.

In resource block 510, OFDM symbol 3 in slot 1 and OFDM symbol 2 in slot 2 carry the NRS REs for antenna ports 0, 1 and 2, while OFDM symbol 6 in slot 1 and OFDM symbol 5 in slot 2 carry the NRS REs for antenna ports 3, 4 and 5. The two OFDM symbols for each set of antenna ports, (0,1,2) and (3,4,5) are spaced apart by 5 symbols in between. This allows the time-variance in a subframe to be effectively captured, and different channels to be estimated with uniform mean square errors. The NRSs are mapped in the order of 0, 1 and 2 from the top to the bottom in OFDM symbol 3 in slot 1 and in the order of 3, 4 and 5 in OFDM symbol 6 in slot 1. The NRSs are mapped in the order of 2, 0 and 1 in OFDM symbol 2 in slot 2 and in the order of 5, 3 and 4 in OFDM symbol 5 in slot 2. The subcarrier indices of the two RS REs for every antenna port are spaced apart by 5 indices in between. This allows the channels to be estimated with similar mean-square errors. In the mappings shown, at an RS RE associated with physical antenna port 2, for example, the power on physical antenna port 2 may be boosted by 3 times, by pulling power unused in the other two RS REs in the same OFDM symbol since physical antenna port 3 does not transmit signals at the RS REs associated with physical antenna ports 4 and 5 in the same OFDM symbol. Similarly, in an extended CP subframe, the NRSs are mapped according to the same principle, as shown in resource block 610 of FIG. 6.

Furthermore, different subcarriers and OFDM symbols can be used for NRS REs as shown in resource block 520 of FIG. 5. Similarly, different subcarriers can be used for NRS REs in an extended CP subframe as well, as shown in resource block 620 of FIG. 6.

Resource block 530 of FIG. 5 illustrates an NRS pattern that results when a cell-specific frequency shifting is applied to the NRS pattern of resource block 520. In this example, the subcarrier indices for the RS REs in resource block 520 are circularly shifted by 1. Cell-specific frequency shifting can be similarly applied in an extended CP subframe as well.

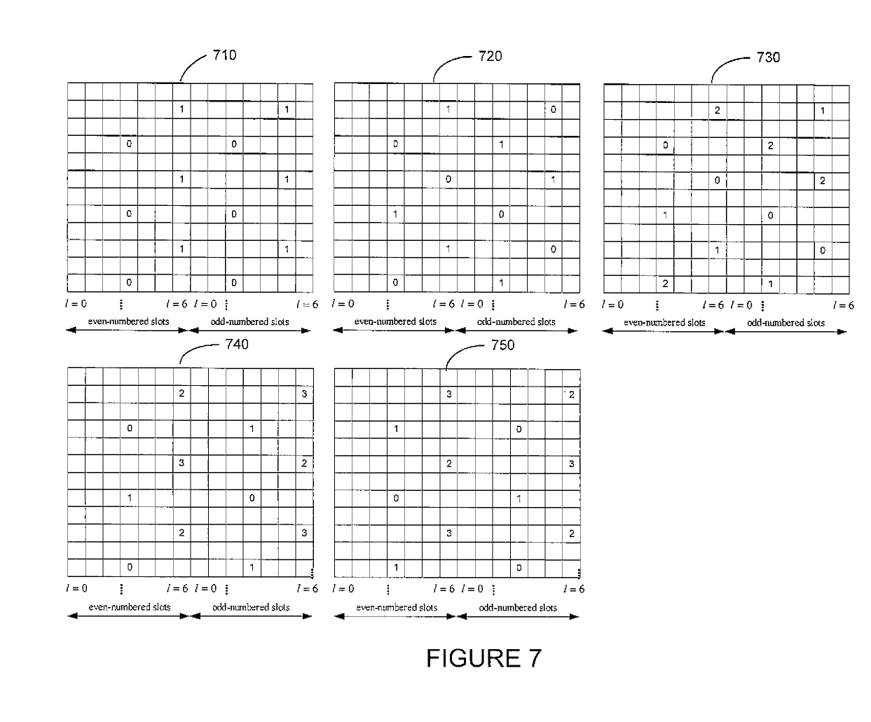

FIG. 7 illustrates reference element patterns for mapping new sets of reference signals for different numbers of new antenna ports according to embodiments of the disclosure.

FIG. 7 illustrates example ways to map NRSs for 2, 3, and 4 new antenna ports onto 12 NRS REs in an RB, where 6, 4, and 3 NRS REs are allocated to each new antenna port, respectively.

In resource block 710, RSs for 2 new antenna ports (0,1) are mapped. OFDM symbol 3 in slot 1 and OFDM symbol 2 in slot 2 carry the RS REs for new antenna port 0 while OFDM symbol 6 in slot 1 and OFDM symbol 5 in slot 2 carry the RS REs for new antenna port 1. In such an embodiment, 6 NRS REs are allocated to each of the 2 new antenna ports.

In some embodiments, in the three RS REs in an OFDM symbol, RSs for two antenna ports are mapped in an alternating manner (or, RS REs of an antenna port can be allocated in a staggered manner). Resource block 720 shows an example of this mapping in the case of mapping 2 new antenna (0,1) ports in the RS pattern.

In other embodiments, in the three RS REs in an OFDM symbol, RSs for three antenna ports are mapped. In resource block 730, RSs for 3 new antenna ports (0,1,2,) are mapped. In such an embodiment, 4 NRS REs are allocated for each of the 3 new antenna ports.

In further embodiments, RSs for 4 new antenna ports (0, 1, 2, 3) are mapped as shown in resource block 740. In such an embodiment, 3 NRS REs are allocated for each of the 4 new antenna ports.

In yet further embodiments as shown in resource block 750, the NRS indices are switched between 0 and 1, and 2 and 3 from those in resource block 740.

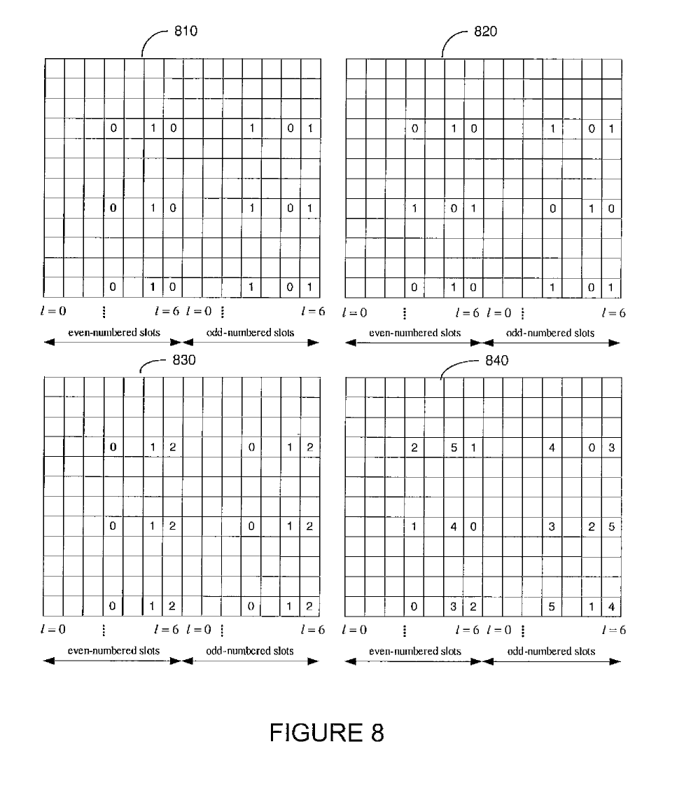

FIG. 8 illustrates reference element patterns for mapping new sets of reference signals for different numbers of new antenna ports according to other embodiments of the disclosure.

FIG. 8 illustrates example ways to map NRSs for 2, 3, and 6 new antenna ports onto 18 NRS REs in an RB, where 9, 6, and 3 NRS REs are allocated to each new antenna port, respectively.

In resource block 810, RSs for 2 new antenna ports (0,1) are mapped. OFDM symbols 3 and 6 in slot 1 and OFDM symbol 5 in slot 2 carry the RS REs for new antenna port 0 while OFDM symbol 5 in slot 1 and OFDM symbols 3 and 6 in slot 2 carry the RS REs for new antenna port 1. In such an embodiment, 9 NRS REs are allocated to each of the 2 new antenna ports.

In some embodiments, in the three RS REs in an OFDM symbol, RSs for two antenna ports are mapped in an alternating manner (or, RS REs of an antenna port can be allocated in a staggered manner). Resource block 820 shows an example of this mapping in the case of mapping 2 new antenna (0,1) ports in the RS pattern.

In other embodiments, in the three RS REs in an OFDM symbol, RSs for three antenna ports are mapped. In resource block 830, RSs for 3 new antenna ports (0,1,2,) are mapped. In such an embodiment, 6 NRS REs are allocated for each of the 3 new antenna ports.

In further embodiments, RSs for 6 new antenna ports (0,1,2,3,4,5) are mapped as shown in resource block 840. In such an embodiment, 3 NRS REs are allocated for each of the 6 new antenna ports.

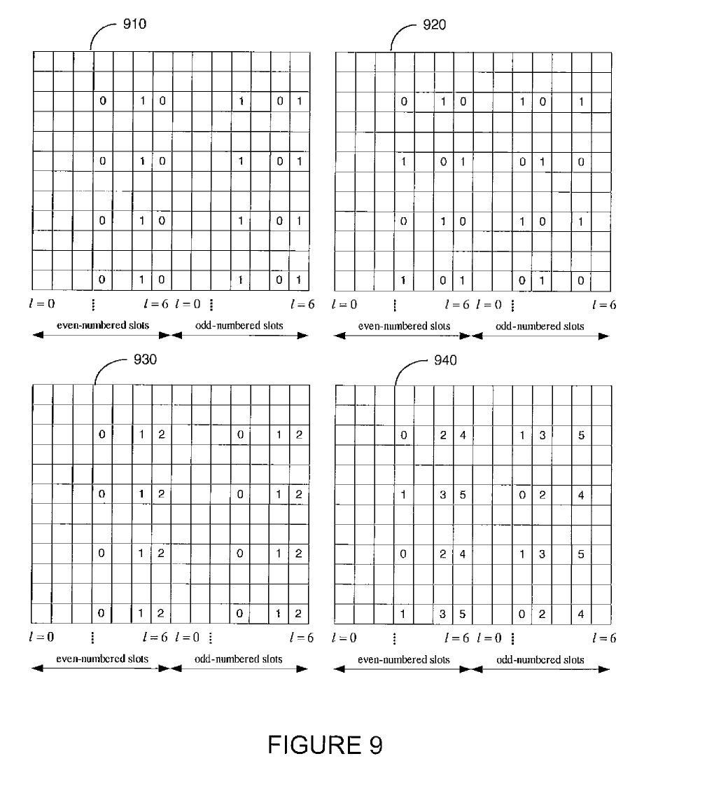

FIG. 9 illustrates reference element patterns for mapping new sets of reference signals for different numbers of new antenna ports according to further embodiments of the disclosure.

FIG. 9 illustrates example ways to map NRSs for 2, 3, and 6 new antenna ports onto 24 NRS REs in an RB, where 12, 8, and 4 NRS REs are allocated to each new antenna port, respectively.

In resource block 910, RSs for 2 new antenna ports (0,1) are mapped. OFDM symbols 3 and 6 in slot 1 and OFDM symbol 5 in slot 2 carry the RS REs for new antenna port 0 while OFDM symbol 5 in slot 1 and OFDM symbols 3 and 6 in slot 2 carry the RS REs for new antenna port 1. In such an embodiment, 12 NRS REs are allocated to each of the 2 new antenna ports.

In some embodiments, in the three RS REs in an OFDM symbol, RSs for two antenna ports are mapped in an alternating manner (or, RS REs of an antenna port can be allocated in a staggered manner). Resource block 920 shows an example of this mapping in the case of mapping 2 new antenna (0,1) ports in the RS pattern.

In other embodiments, in the three RS REs in an OFDM symbol, RSs for three antenna ports are mapped. In resource block 930, RSs for 3 new antenna ports (0,1,2,) are mapped. In such an embodiment, 8 NRS REs are allocated for each of the 3 new antenna ports.

In further embodiments, RSs for 6 new antenna ports (0,1,2,3,4,5) are mapped as shown in resource block 940. In such an embodiment, 4 NRS REs are allocated for each of the 6 new antenna ports.

In some embodiments, the NRS pattern can be different for different RBs (e.g., one DRS pattern is defined in each resource block group, an NRS pattern switching is applied to two consecutive RBs, and so on). A resource block group (RBG) is defined in 3GPP TS 36213 V8.5.0, “3^{rd} Generation Partnership Project; Technical Specification Group Radio Access Network; Evolved Universal Terrestrial Radio Access (E-UTRA); Physical layer procedures (Release 8)”, December 2008, which is hereby incorporated by reference in its entirety. According to 3GPP TS 36213 V8.5.0, a resource block group (RBG) is a set of consecutive physical resource blocks (PRBs). The resource block group size (P) is a function of the system bandwidth as shown in Table 7.1.6.1-1 reproduced below:

| System Bandwidth N_{RB}^{DL} | RBG Size (P) |
|---|---|
| <10 | 1 |
| 11-26 | 2 |
| 27-63 | 3 |
| 64-110 | 4 |

In one example of NRS pattern switching, the DRS pattern in resource block 740 of FIG. 7 is used in RBs having an even index while an index-switched pattern of resource block 740 (i.e., resource block 750) is used in RBs having an odd index. As a results, when an even number of consecutive RBs are allocated, the RS REs in an OFDM symbol for an antenna port are evenly spaced in the subcarrier domain.

In one embodiment of the disclosure, a set of CRS (e.g., the new CRS in LTE-A) can be allocated in a time-sparse and/or frequency-sparse manner. In addition, the time-frequency resources assigned for the CRS can be differently assigned among the adjacent cells. To facilitate this assignment, two methods are considered.

In one method, an eNodeB in a cell broadcasts a control signal to the UEs in the cell. The control signal contains a message that provides information regarding the time-frequency resources assigned for the CRS. In another method, a few parameters available to UEs and eNodeB in a cell (e.g., cell-ID, slot/subframe number, etc.) are associated with the assignment of the CRS resources.

The CRS can be allocated either in a regular or in a non-regular way in time and/or frequency.

In one embodiment, the 6 (or 4) NRSs in an RB constructed by NRS mapping are used as 6 (or 4) new CRSs, so as to have 8 CRSs in an RB in a subframe (or in a slot) together with the LTE 2-CRS (or 4-CRS).

In another embodiment, the 2 NRSs in an RB constructed by NRS mapping are used as 2 new CRSs, so as to have 4 CRSs in an RB in a subframe (or in a slot) together with the LTE 2-CRS. In one example, NRSs in the pattern in resource block 720 of FIG. 7 is used for the two additional CRSs in LTE, together with the LTE 2-CRS.

In a first embodiment, the CRS is allocated in every A^{th} subframe in a cell.

In a second embodiment, the CRS is allocated in every B^{th} slot in a cell.

In a third embodiment, the CRS is allocated in every C^{th} RB in a specific set of either subframes or slots in a cell.

In a fourth embodiment, the CRS is allocated in every D^{th} RBG in a specific set of either subframes or slots in a cell.

Subsets of these four embodiments can be jointly used. For example, CRS allocation according to the first and third embodiments are jointly used, so that the CRS is allocated in every A^{th} subframe in a cell, and in subframes where CRS is allocated, the CRS is allocated in every C^{th} RB. In some embodiments, the values of A, B, C, and/or D are signaled to a subscriber station or user equipment (UE).

In these embodiments, the set of time-frequency resources containing the CRS can be cell-specific. In such a case, the set of time-frequency resources can be dependent on Cell_ID n_{cell} and other parameters (e.g., subframe number n_{SF}, slot number nₛₗₒₜ, etc).

In one embodiment, a subframe number (or slot number) satisfying the following condition of Equation 1 below is allowed to have the CRS (with CRS allocation according to the first or second embodiment):

n_{SF}(n_{cell})mod A=n_{cell} mod A(or nₛₗₒₜ(n_{cell})mod B=n_{cell} mod B), [Eqn. 1]

where n_{SF}(n_{cell}) is a slot number, and nₛₗₒₜ(n_{cell}) is a subframe number in cell n_{cell}. Accordingly, starting from subframe n_{SF}^{offset}(=n_{cell} mod A), every A^{th} subframe is allowed to have the CRS. Starting from slot nₛₗₒₜ^{offset}(=n_{cell} mod B), every B^{th} slot is allowed to have the CRS.

With regard to n mod 1=1, when A=1, every subframe carries (or may carry) the CRS (with CRS allocation according to the first embodiment).

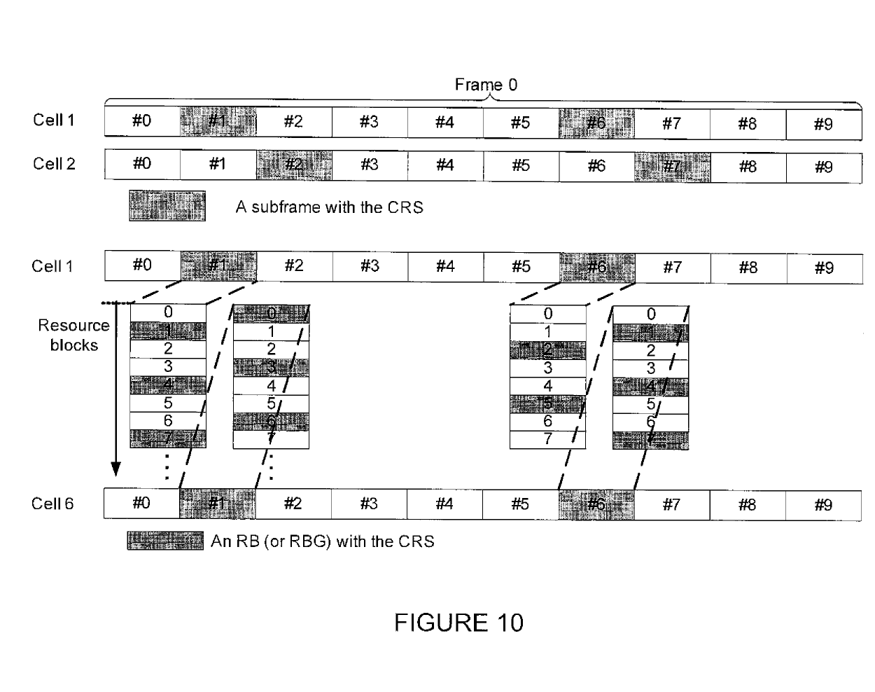

FIG. 10 illustrates CRS allocation according to an embodiment of the disclosure.

As shown in FIG. 10, A=5, and the CRS is allocated in every 5^{th} subframe. According to this condition, in cell 1, subframes 1, 6, 11, 16, . . . carry the CRS while in cell 2, subframes 2, 7, 12, 17, . . . carry the CRS.

In another embodiment, RB number (or RBG number) satisfying the following condition of Equation 2 below is allowed to have the CRS (with CRS allocation according to the third or fourth embodiment):

n_{RB}(n_{cell})mod C=n_{cell} mod C

(or n_{RBG}(n_{cell})mod D=n_{cell} mod D), [Eqn. 2]

where n_{RB}(n_{cell}) is an RB number, and n_{RBG}(n_{cell}) is an RBG number in cell n_{cell}. Accordingly, starting from RB n_{RB}^{offset}(=n_{cell} mod C) (or RBG n_{RBG}^{offset}(=n_{cell} mod D)), every C^{th} RB (or every D^{th} RBG) may have the CRS. If C=3, for example, cell 1 has the CRS in RBs 1, 4, 7, etc., while cell 2 has the CRS in RBs 2, 5, 8, etc.

Other example conditions are as follows:

n_{RB}(n_{cell})mod C=n_{cell} mod C. [Eqn. 3]

According to Equation 3, starting from RB n_{RB}^{offset}(=n_{cell} mod C), every C^{th} RB is allowed to have the CRS.

n_{RB}(n_{cell})mod C=[n_{cell}+n_{SF}(n_{cell})] mod C

and n_{SF}(n_{cell})mod A=n_{cell} mod A. [Eqn. 4]

According to Equation 4, starting from subframe n_{SF}^{offset} (=n_{cell} mod A), every A^{th} subframe is allowed to have the CRS. In the subframes having the CRS, starting from RB n_{RB}^{offset}(=[n_{cell}+n_{SF}(n_{cell})] mod C), every C^{th} RB is allowed to have the CRS.

n_{RB}(n_{cell})mod C=[n_{cell}+nₛₗₒₜ(n_{cell})] mod C

and nₛₗₒₜ(n_{cell})mod B=n_{cell} mod B, and [Eqn. 5]

n_{RB}(n_{cell})mod C=[n_{cell}+n_{SF}^{count}(n_{cell})] mod C

and n_{SF}(n_{cell})mod A=n_{cell} mod A, [Eqn. 6]

where n_{SF}^{count}(n_{cell}) is the number of subframes carrying the CRS before the current subframe n_{SF}(n_{cell}), which is counted from a reference subframe. The information on the reference subframe can be broadcasted to UEs in a cell by an eNodeB (e.g., by higher-layer signaling).

According to Equations 5 and 6, starting from subframe n_{SF}^{offset}(=n_{cell} mod A), every A^{th} subframe has (or may have) the CRS. In the subframes having the CRS, starting from RB n_{RB}^{offset}(=[n_{cell}+n_{SF}^{count}(n_{cell})] mod C), every C^{th} RB is allowed to have the CRS.

n_{RB}(n_{cell})mod C=[n_{cell}+nₛₗₒₜ^{count}(n_{cell})] mod C

and nₛₗₒₜ(n_{cell})mod B=n_{cell} mod B, [Eqn. 7]

where nₛₗₒₜ^{count}(n_{cell}) is the number of slots carrying the CRS before the current slot nₛₗₒₜ(n_{cell}), which is counted from a reference slot. The information on the reference slot can be broadcasted to UEs in a cell by an eNodeB (e.g., by higher-layer signaling).

Similar example conditions can be constructed using n_{RBG}(n_{cell}) and mod D as well. In FIG. 10, A=5, and the CRS is allocated in every 5^{th} subframe. In a subframe carrying the CRS, the CRS is allocated in every 3^{rd} RB (C=3). In this example, the time-frequency resources satisfying the condition n_{RB}(n_{cell})mod C=[n_{cell}+n_{SF}^{count}(n_{cell})] mod C of Equation 7 and n_{SF}(n_{cell})mod A=n_{cell} mod A carries the CRS, where the reference subframe is assumed to be subframe 0. Therefore, in cell 1, subframes 1, 6, 11, 16 carry the CRS, and in these subframes, the CRS is allocated in RBs 1, 4, 7, . . . in subframe 1. While in cell 6, subframes 1, 6, 11, 16 carry the CRS, and in these subframes, the CRS is allocated in RBs 0, 3, 6, . . . in subframe 1.

In one embodiment of this disclosure, the eNodeB sends different downlink control information (DCI) formats to a UE depending on the number of layers which the eNodeB intends to transmit to the UE. A DCI format intended to a UE contains information on the resource allocation (RA: scheduled RBs), modulation and coding rate (MCS), rank information (RI: the number of layers in the case of spatial multiplexing mode and multi-layer beamforming mode), precoder matrix information (PMI), etc.

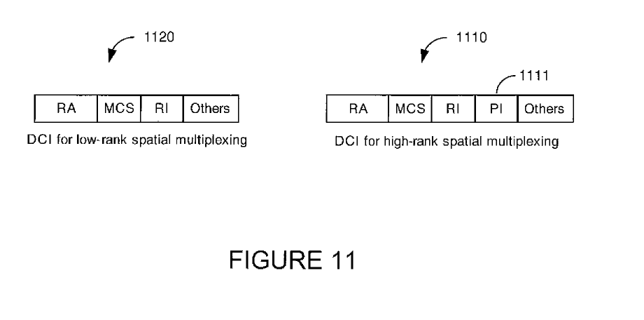

FIG. 11 illustrates downlink control information (DCI) formats according to an embodiment of the disclosure.

In one embodiment of the disclosure, eNodeB transmits two different DCI formats depending on whether the number of layers is greater than (or equal to) N_{Layers}. In a particular embodiment, if the number of layers is greater than N_{Layers}, a DCI format 1110 containing precoding information (PI) 1111 is transmitted. Otherwise, a DCI format 1120 that does not contain the PI is transmitted.

The PI field contains information on the precoding matrices. The RI field in both formats of FIG. 11 contains information on the number of transmission layers or the transmission rank.

In one embodiment, the RI field can be composed of ┌ log₂(N_{Layers}^{max})┐ bits, where N_{Layers}^{max} is the maximum number of layers allowed to a UE in a transmission mode. As such, the bits in the RI field directly indicate the transmission rank (or the number of layers). In a particular embodiment, the transmission rank is greater than the decimal representation of the bits in the RI field by one. For example, if N_{Layers}^{max}=8, then the RI field is composed of 3 bits. In such an embodiment, when the RI field is binary [011] (=decimal 3), for example, this implies that in the upcoming downlink transmission associated with the current DCI, the transmission rank is 4 (=3+1).

In another embodiment, the RI field may be composed of

$$⌈ {log}_{2} ( \frac{{N}_{Layers}^{max}}{2} ) ⌉$$

bits, and the bits in the RI field may have different meanings in different DCI formats. For example, in a particular embodiment, if N_{Layers}^{max}=8 then the RI field is composed of 2 bits. When RI field is binary [01] (=decimal 1), for example, this implies rank 2 (=1+1) in a low-rank DCI format, while this implies rank 6 (4+1+1) in a high-rank DCI format. This example can be generalized as, with a low-rank DCI format, the transmission rank is greater than the decimal representation of the RI field by one. With a high-rank DCI format, the transmission rank is greater than the decimal representation of the RI field by

$$( 1 + \frac{{N}_{Layers}^{max}}{2} ) .$$

In one embodiment of the disclosure, the DRS is allocated in the RBs where UEs will receive downlink transmissions. Either a specific DCI format used for a DL grant, or a transmission rank that can be found in the DCI, or both, may imply a specific RS pattern.

The DCI formats in FIG. 11 can be used in different transmission modes. At a UE in a transmission mode, a fixed number of DCI formats can be recognized. In a particular embodiment, for a UE in high-order spatial multiplexing transmission mode that supports up to N_{Layer}^{max}-layer transmissions (e.g., N_{Layers}^{max}=8), or for a UE in multi-layer or in single-layer beamforming transmission mode, the eNodeB may transmit more than one type of DCI format having different payloads (or number of information bits) in different subframes. In such a case, the UE attempts to decode a DCI message intended to itself, assuming more than two different payloads.

For a UE in one transmission mode (transmission mode A), the eNodeB transmits one of the two DCI formats in FIG. 11 in a subframe, depending on the intended transmission ranks.

For a UE in another transmission mode (transmission mode B), the eNodeB transmits one of the two DCI formats (in multi-layer beamforming mode), one for 2-Tx diversity or single antenna transmission that does not carry RI and the DCI format 1120. When the DCI format 1120 is received at a UE, the UE reads the RI field to determine a specific DRS mapping pattern for UE-specific antenna ports in the corresponding downlink transmission. On the other hand, when the DCI format for 2-Tx diversity or single antenna transmission is received, a UE assumes LTE 2-CRS transmissions only without any DRS transmissions.

For a UE in yet another transmission mode (transmission mode C), the eNodeB transmits one of the three DCI formats, one for 4-Tx diversity or single antenna transmission that does not carry RI and the two DCI formats in FIG. 11.

A few different DRS allocation methods are considered that depend on the transmission ranks and the DCI format used in the DL grant.

In one embodiment (DRS allocation method A), the total number of DRS REs in an RB increases as the number Of layers increases. For example, in a particular embodiment, given a DRS-RE pattern with transmission rank r, DRS REs for UE-specific antenna ports 0, . . . , r−1 carry RSs, while DRS REs for other antenna ports may carry data. The DRS REs for a UE-specific antenna port iε{0, . . . , r−1} can be precoded using the precoding vector used for transmission layer i. As an example, consider a UE in transmission mode B supporting up to 6 layer transmissions. Transmissions with ranks 1, 2, . . . , 6 can be initiated by the DL grant using the DCI format 1120, and the DRS pattern in resource block 840 of FIG. 8 can be used, where the number of DRS REs per antenna port is 3. As the number of transmission layers increases by 1, the total number of DRS REs that carry RSs for UE specific antenna ports increases by 3. On the other hand, fall-back mode transmission using 2-Tx diversity can be initiated by the other DCI format in transmission mode B, and in the corresponding subframe, the UE assumes LTE 2-CRS transmission only.

In another embodiment (DRS allocation method B), the total number of DRS REs remains the same as the transmission rank increases. In such a case, the number of DRS REs per antenna port may get reduced as the number of layers increases. For example, in a particular embodiment, with transmission rank r, the DRS REs for a UE-specific antenna port iε{0, . . . , r−1} can be precoded using the precoding vector used for transmission layer i. As an example, consider a UE in transmission mode B supporting up to 2 layer transmissions. Transmissions with ranks 1 and 2 can be initiated by the DL grant using the DCI format 1120. In transmissions with rank 1, the 12 DRS pattern in resource block 410 is used. In transmissions with rank 2, the 12 DRS REs are partitioned into two (as shown in resource block 720) with 6 REs carrying the RS for one UE-specific antenna port, and the other 6 REs carrying the RS for the other UE-specific antenna port.

In a further embodiment (DRS allocation method C), the total number of DRS REs increases up to a certain number as the number of layers increases, then the total number of DRS REs remains the same if the number of layers further increases. For example, in a particular embodiment, when an RB has CRS REs for Nₚₒᵣₜₛ^{CRS} cell-specific antenna ports among the N_{Tx} cell-specific antenna ports, the number of DRS REs in an RB increases up to N_{Layers}(=N_{Tx}−Nₚₒᵣₜₛ^{CRS}) where N_{Tx} is the number of transmit antennas at the eNodeB. With transmission rank r up to N_{Layers}, the DRS REs for a UE-specific antenna port iε{0, . . . , r−1} can be precoded using the precoding vector used for transmission layer i.

On the other hand, when the number of layers is greater than (or equal to) N_{Layers}, the DRS REs may carry different kinds of RSs.

In one particular embodiment, the DRS REs carry RSs associated with N_{Layers} cell-specific antenna ports.

In another particular embodiment, the DRS REs carry RSs associated with N_{Layers} UE-specific antenna ports. In one example, the RS associated with each UE-specific antenna port is precoded with a precoding vector for each of the first N_{Layers} transmission layers. In another example, the RS associated with each UE-specific antenna port is partially-precoded with precoding vectors for each of the first N_{Layers} transmission layers with Nₚₒᵣₜₛ^{CRS} cell-specific antenna ports turned off.

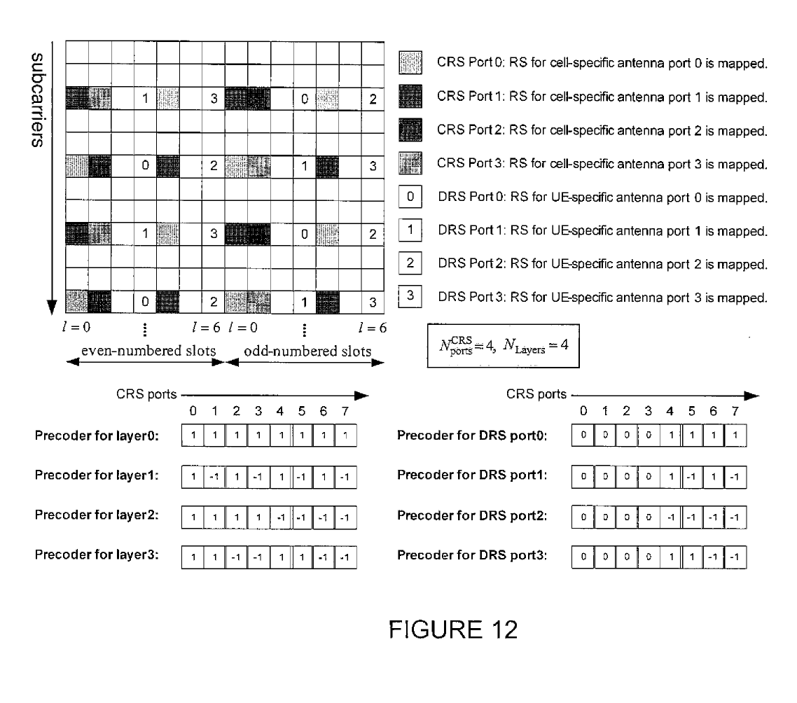

FIG. 12 illustrates partially-precoded UE-specific reference signal ports according to an embodiment of the disclosure.

As an example, consider a UE in transmission mode A supporting up to N_{Layers}^{max}=8 layer transmissions. An RB has LTE CRS REs for Nₚₒᵣₜₛ^{CRS}=4 cell-specific antenna ports, and the eNodeB has N_{Tx}=8 transmit antennas. Transmissions with ranks 1, 2, 3 and 4 can be initiated by the DL grant using the DCI format 1120. The number of DRS REs in an RB increases by 3 as the number of layers increases up to N_{Layers}=N_{Tx}−Nₚₒᵣₜₛ^{CRS}=4 as in the DRS pattern in resource block 1210 of FIG. 12. On the other hand, transmissions with ranks larger than N_{Layers}=4 can be initiated by the DL grant using the DCI format 1110, and the number of DRS REs stays at 12.

In another method (DRS allocation method D), if the transmission rank is less than a certain number, one DRS pattern is used in every allocated RB. Otherwise, the DRS pattern can be different in different RBs (e.g., one DRS pattern is defined per RBG). With transmission rank r, the DRS REs for a UE-specific antenna port i can be precoded using the precoding vector used for transmission layer i. As an example, consider a UE in transmission mode A supporting up to N_{Layers}^{max}=8 layer transmissions. Transmissions with ranks 1, 2, 3 and 4 can be initiated by the DL grant using the DCI format 1120, while transmissions with ranks larger than N_{Layers}=4 can be initiated by the DL grant using the DCI format 1110. Following DRS allocation methods C and D, if the rank is 1, 2, or 3, then the DRS pattern shown in resource block 410, 710, or 730, respectively, is used. If the rank is greater than 4, the RS pattern switching is used. If the RB index is even, the pattern in resource block 740 is used while if the RB index is odd, the pattern in resource block 750 is used.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A base station comprising:
a downlink transmit path comprising circuitry configured to transmit a plurality of reference signals in two or more resource blocks, each resource block comprising S OFDM symbols, each of the S OFDM symbols comprising N subcarriers, and each subcarrier of each OFDM symbol comprises a resource element; and
a reference signal allocator configured to allocate the plurality of reference signals to selected resource elements of the two or more resource blocks according to a reference signal pattern,
wherein a same pre-coding matrix is applied across the two or more resource blocks.

2. A base station in accordance with claim 1 wherein a total size of the two or more resource blocks is equal to a size of a Resource Block Group (RBG) as defined in a Long Term Evolution (LTE) specification.

3. A base station in accordance with claim 1 wherein the reference signal pattern is applied to the two or more resource blocks when a transmission rank is greater than a pre-determined number.

4. A subscriber station comprising:
a downlink receive path comprising circuitry configured to receive a plurality of reference signals in two or more resource blocks, each resource block comprising S OFDM symbols, each of the S OFDM symbols comprising N subcarriers, and each subcarrier of each OFDM symbol comprises a resource element; and
a reference signal receiver configured to receive the plurality of reference signals from selected resource elements of the two or more resource blocks according to a reference signal pattern,
wherein a same pre-coding matrix is applied across the two or more resource blocks.

5. A subscriber station in accordance with claim 4 wherein a total size of the two or more resource blocks is equal to a size of a Resource Block Group (RBG) as defined in a Long Term Evolution (LTE) specification.

6. A subscriber station in accordance with claim 4 wherein the reference signal pattern is applied to the two or more resource blocks when a transmission rank is greater than a pre-determined number.

7. A method of operating a subscriber station, the method comprising:
receiving, by way of a downlink receive path, a plurality of reference signals in two or more resource blocks, each resource block comprising S OFDM symbols, each of the S OFDM symbols comprising N subcarriers, and each subcarrier of each OFDM symbol comprises a resource element; and
receiving, by way of a reference signal receiver, the plurality of reference signals from selected resource elements of the two or more resource blocks according to a reference signal pattern,
wherein a same pre-coding matrix is applied across the two or more resource blocks.

8. A method in accordance with claim 7 wherein a total size of the two or more resource blocks is equal to a size of a Resource Block Group (RBG) as defined in a Long Term Evolution (LTE) specification.

9. A method in accordance with claim 7 wherein the reference signal pattern is applied to the two or more resource blocks when a transmission rank is greater than a pre-determined number.

10. A base station comprising:
a downlink transmit path comprising circuitry configured to transmit a plurality of cell-specific reference signals across a plurality of resource blocks; and
a reference signal allocator configured to allocate the plurality of cell-specific reference signals in an fth resource block and in every ith resource block starting from the fth resource block in the plurality of resource blocks,
wherein i and f are integers, and f is a resource block offset based at least partly upon a Cell_ID of a base station.

11. A base station in accordance with claim 10 wherein the reference signal allocator is configured to allocate the plurality of cell-specific reference signals in the fth resource block and in every ith resource block starting from the fth resource block using a same cell-specific reference signal pattern.

12. A base station in accordance with claim 10 wherein i is signaled from the base station.

13. A base station in accordance with claim 10 wherein i is based at least partly upon a number of resource blocks in a Resource Block Group (RBG).

14. A base station in accordance with claim 10 wherein the offset f is calculated using the follow equation:
f=(Cell_ID)mod(i).

15. A subscriber station comprising:
a downlink receive path comprising circuitry configured to receive a plurality of cell-specific reference signals across a plurality of resource blocks; and
a reference signal receiver configured to receive the plurality of cell-specific reference signals in an fth resource block and in every ith resource block starting from the fth resource block in the plurality of resource blocks,
wherein i and f are integers, and f is a resource block offset based at least partly upon a Cell_ID of a base station.

16. A subscriber station in accordance with claim 15 wherein the plurality of cell-specific reference signals in the fth resource block and in every ith resource block starting from the fth resource block are allocated using a same cell-specific reference signal pattern.

17. A subscriber station in accordance with claim 15 wherein i is signaled from the base station.

18. A subscriber station in accordance with claim 15 wherein i is based at least partly upon a number of resource blocks in a Resource Block Group (RBG).

19. A subscriber station in accordance with claim 15 wherein the offset f is calculated using the follow equation:
f=(Cell_ID)mod(i).

20. A method of operating a subscriber station, the method comprising:
receiving, by way of a downlink receive path, a plurality of cell-specific reference signals across a plurality of resource blocks; and
receiving, by way of a reference signal receiver, the plurality of cell-specific reference signals in an fth resource block and in every ith resource block starting from the fth resource block in the plurality of resource blocks,
wherein i and f are integers, and f is a resource block offset based at least partly upon a Cell_ID of a base station.

21. A method in accordance with claim 20 wherein the plurality of cell-specific reference signals in the fth resource block and in every ith resource block starting from the fth resource block are allocated using a same cell-specific reference signal pattern.

22. A method in accordance with claim 20 wherein i is signaled from the base station.

23. A method in accordance with claim 20 wherein i is based at least partly upon a number of resource blocks in a Resource Block Group (RBG).

24. A method in accordance with claim 20 wherein the offset f is calculated using the follow equation:
f=(Cell_ID)mod(i).
